(19) United States
(12) Patent Application Publication
(10) Pub. No.: US 2015/0210563 A1
(43) Pub. Date: Jul. 30, 2015

(54) WATER PURIFICATION BY BATCH CRYSTALLIZATION PROCESS

(71) Applicant: SHARP KABUSHIKI KAISHA, OSAKA (JP)

(72) Inventors: Michael Charles Tomlin, Oxfordshire (GB); Philip Mark Shryane Roberts, Woodcote (GB); Sinéad Marie Matthews, Oxfordshire (GB)

(73) Assignee: SHARP KABUSHIKI KAISHA, OSAKA (JP)

(21) Appl. No.: 14/163,075

(22) Filed: Jan. 24, 2014

(51) Int. Cl. C02F 1/22; F25D 31/00

(52) U.S. Cl. CPC C02F 1/22; F25D 31/005

(57) ABSTRACT

A water purifier includes a first crystallization chamber and a second crystallization chamber that each receives a supply of input water; wherein each of the first and second crystallization chambers is a freeze/thaw chamber in which water is alternately frozen and thawed. A refrigerant circuit alternately supplies cold refrigerant to freeze the input water in one of the crystallization chambers, and supplies heated refrigerant to the other of the crystallization chambers to thaw the purified water. The first and second crystallization chambers operate concurrently and out-of-phase whereby heat recovered from freezing in one of the crystallization chambers is transferred by the refrigerant circuit for use in thawing in the other of the crystallization chambers. The refrigerant circuit includes a desuperheater that at least partially condenses heated refrigerant such that waste heat of compression generated by the desuperheater is rejected into wastewater via contraflow heat exchange with the heated refrigerant.

### TECHNICAL FIELD

This invention relates to water purification methods using a batch crystallization process, where a fraction of water is frozen then separated from the non-frozen fraction and then thawed.

### BACKGROUND ART

Water purification describes any process where dissolved impurities are removed from the input water. There is no quantification of this process other than the output “purified” water containing fewer dissolved and suspended impurities than the input “unpurified” water. Other examples of water treatments include water softening—the removal of calcium and magnesium cations from water, and water sterilization—the removal or inactivation of microorganisms such as pathogenic bacteria from water.

Water purification by freezing has been shown to significantly reduce concentrations of chemical and biological species. (See US EPA report “Traces of Heavy Metals in Water Removal Processes and Monitoring” 1973 EPA-902/9-74-001; Conlon 1992 http://www.wmconlon.com/wp-content/uploads/papers/IATC92.pdf accessed 26/09/13 09:45.) If a fraction of a volume of water is frozen, the increased solubility of dissolved species in the liquid phase means that impurities are concentrated in the non-frozen component. By separating the frozen and non-frozen components and then thawing the ice, the resultant water is of higher purity than the input water. Repeating this freeze-thaw process increases the percentage removal of impurities. The energy cost of multiple freeze-thaw processes can be prohibitively high for a domestic purification system, so methods of recycling the sensible and latent heat removed from the water during the freeze purification process have been developed by others to improve the efficiency of the process:

Chang (U.S. Pat. No. 4,799,945 issued Jan. 24, 1989) describes a dual chamber freezing system for water purification. In such systems the two chambers are out-of-phase with one another; when one is freezing water the other is thawing ice. The purported advantages of such devices over a continuous freezing process are the decreased engineering complexity and improved energy efficiency, making it more suitable for domestic or small scale use. However, the energy consumption of a device of this type is still not competitive with other water purification techniques.

Conlon (U.S. Pat. No. 5,438,843 issued Aug. 8, 1995) discloses an advanced batch crystallization system, whereby the energy efficiency is increased by using a cascading two stage refrigeration system and rejecting heat to the environment via an auxiliary cooling water circuit. Energy to thaw the purified ice is provided by recirculating purified water through the primary refrigerant condenser and one batch crystallization chamber whilst the evaporating refrigerant froze water in the alternate batch crystallization chamber. A design of this type also decreases the engineering complexity of the system by using fewer valves to control the flow of refrigerant to each freezing chamber.

In both the Chang and Conlon disclosures, the water is frozen by direct heat exchange with the refrigerant whose direction of flow is reversed to alternate the function of each chamber (freezing to thawing). Crucially, both inventions are limited in terms of energy efficiency by the use of cascading two-stage refrigeration systems to enable heat to be rejected to the environment at high temperature through the use of an auxiliary cooling water circuit.

In other methods to improve the energy efficiency of the freeze purification process, freeze purification has been combined with other cooling demands such as a domestic fridge/freezer (see Ashley U.S. Pat. No. 3,338,065 issued Aug. 29, 1967; Ruff U.S. Pat. No. 5,207,761 issued May 4, 1993). U.S. Pat. No. 3,338,065 describes an elongated water tank with a cooling bottom surface where ice is formed and floats to the top of the tank. The water tank is not stirred to enable the ice to float to the top of the tank, and therefore the purification process is considered static. The ice and water are separated and the ice subsequently melted to produce purified water. Aspects of this system also include combining with a domestic fridge/freezer by coupling the required evaporators in series (i.e. freezing performed by direct heat exchange with the refrigerant); heat from the refrigerator would be used to defrost the ice. Such a process has a number of potential drawbacks such as a low level of impurity removal due to the static freezing purification method and low energy efficiency of the process.

U.S. Pat. No. 5,207,761 describes a refrigerator and water purifier with a common evaporator. A device of this type uses an ice forming plate cooled by direct contact with the refrigerant for the purpose of freezing water to purify it. The process is dynamic as the water is flowed over the ice forming plate; this enhances the purification process (see R. A. Baker, Water Research, 1967, 1, 61-77). When an appropriate amount of ice has been formed on the plate, the surface is heated to release the ice into a bin where it is either stored as ice cubes or to a storage tank where it is thawed. The surface can either be heated directly with hot gas as part of the refrigerant cycle or using an electric heater. On the other side of the ice forming plate is a storage space which is cooled by the use of a fan to aid thermal advection. Such a system requires a complex series of valves to ensure that the required volume of purified ice/water is produced in addition to maintaining a stable temperature in the storage space. Furthermore, the energy efficiency is limited by the method of cooling the storage space.

Other conventional systems are based on the use of two four-way reversing valves to permit the reversing of the direction of refrigerant flow to the heat exchangers. For example, Komori et al (WO 2012147366 published Nov. 1, 2012) and Heys et al (EP 1471316 published Oct. 27, 2004) describe reversible heat pumps for air conditioning systems using two four-way valves. In both systems a reversible heat pump uses two four-way switching valves to enable the suction and discharge refrigerant flows to be switched between the “inside” and “outside” heat exchangers whilst the flow through the expansion means is maintained as unidirectional. Neither of these disclosures describes the use of unidirectional superheaters and desuperheaters as part of the reversible circuit, and so they are not capable of maximizing the specific cooling capacity, through the use of a superheater, nor removing superheat from the refrigerant with a minimal supply of cooling liquid.

Other circuits which use desuperheaters include Yaeger et al. (U.S. Pat. No. 4,316,367 issued on Feb. 23, 1982) and Holm et al. (EP 2368081 published on Sep. 28, 2011). Both of the aforementioned systems use a desuperheater to transfer refrigerant superheat to a low flow of water through a contraflow heat exchanger. These systems offer higher outlet water temperatures than can be achieved with a condenser, but their application is clearly described as being for a hot water or heating system, not for heat rejection to assist a cooling circuit. Furthermore these systems lack any means for the condenser and evaporator to be reversed whilst the function of the desuperheater remains continuous.

Therefore, none of the described conventional systems provides for a system or device which purifies water via an energy efficient process based on at least one freeze/thaw cycle, using multiple out-of-phase batch crystallisation chambers for energy recovery, wherein excess heat in the refrigerant is transferred to waste water through a contraflow desuperheater without requiring an auxiliary cooling circuit.

### SUMMARY OF INVENTION

The object of this invention is to provide an economical method of water purification by a batch crystallization method. No conventional system minimizes energy and water consumption in a way that provides a batch crystallization method that is comparable to other water purification techniques such as reverse osmosis.

Described is a system which balances energy and water demand by recycling sensible and latent heat between the freezing and thawing processes of the purification and transferring the waste heat from the system to a mixed stream of supply and waste-water through a contraflow desuperheater. The desuperheater acts to reduce the condensing pressure thereby reducing specific electrical load on the compressor. This process is economical by using out-of-phase batch crystallization processes with internal heat recovery, to reduce the net cost of operation. Specifically, electricity consumption is reduced by dumping waste heat to cold wastewater from the purification process through a refrigerant desuperheater, thus eliminating the need for an auxiliary heat sink.

Exemplary embodiments of the invention include the following five components:
1) Reversible evaporators/condensers to act as batch crystallization chambers with means of agitating water to be purified;
2) Refrigeration circuit containing two four-way reversing valves;
3) Supply and drain of domestic water;
4) Collection tank for purified water; and
5) Unidirectional desuperheater.

The use of two four-way switching valves to permits the reversing of the direction of refrigerant flow to the batch crystallization chambers; i.e. the chambers can switch between freezing and thawing modes without affecting the unidirectional flow of refrigerant required by components such as the superheater and desuperheater.

The use of a desuperheater permits the removal of heat from the circuit with a minimal pre-cooled supply of fluid (i.e. the waste-water from the purification process) by contraflow heat exchange with the refrigerant.

In accordance with the above features, and aspect of the invention is a water purifier. In exemplary embodiments, the water purifier includes a first crystallization chamber and a second crystallization chamber that each receives a supply of input water; wherein each of the first and second crystallization chambers is a freeze/thaw chamber in which water is alternately frozen and thawed. A refrigerant circuit alternately supplies cold refrigerant to freeze the input water in one of the crystallization chambers, and supplies heated refrigerant to the other of the crystallization chambers to thaw the input water. The first and second crystallization chambers operate concurrently and out-of-phase whereby heat recovered from freezing in one of the crystallization chambers is transferred by the refrigerant circuit for use in thawing in the other of the crystallization chambers. The refrigerant circuit includes a desuperheater that at least partially condenses heated refrigerant such that waste heat of compression generated by the desuperheater is rejected into wastewater via contraflow heat exchange with the heated refrigerant.

Another aspect of the invention is a method of purifying water. In exemplary embodiments, the method of purifying water includes the steps of:

supplying input water to each of a first crystallization chamber and a second crystallization chamber; wherein each of the first and second crystallization chambers is a freeze/thaw chamber in which water is alternately frozen and thawed; and circulating a refrigerant through a refrigerant circuit to alternately supply cold refrigerant to freeze the input water in one of the crystallization chambers, and supply heated refrigerant to the other of the crystallization chambers to thaw the input water. The first and second crystallization chambers are operated concurrently and out-of-phase whereby heat recovered from freezing in one of the crystallization chambers is transferred by the refrigerant circuit for use in thawing in the other of the crystallization chambers. The refrigerant circuit includes a desuperheater that at least partially condenses heated refrigerant such that waste heat of compression generated by the desuperheater is rejected into wastewater via contraflow heat exchange with the heated refrigerant.

To the accomplishment of the foregoing and related ends, the invention, then, comprises the features hereinafter fully described and particularly pointed out in the claims. The following description and the annexed drawings set forth in detail certain illustrative embodiments of the invention. These embodiments are indicative, however, of but a few of the various ways in which the principles of the invention may be employed. Other objects, advantages and novel features of the invention will become apparent from the following detailed description of the invention when considered in conjunction with the drawings.

### BRIEF DESCRIPTION OF DRAWINGS

In the annexed drawings, like references indicate like parts or features:

FIG. 1 is a schematic diagram of an exemplary embodiment depicting a water purifier based on multiple out-of-phase batch crystallization chambers with two four-way switching valves and a unidirectional desuperheater

FIG. 2a is a schematic diagram of a further embodiment depicting a water purifier based on multiple out-of-phase batch crystallization chambers with two four-way switching valves and a unidirectional desuperheater and a secondary cooling demand with thermostatic regulation means.

FIG. 2b shows the system of FIG. 2a without a mechanism for independently controlling the temperature of the secondary cooling demand.

FIG. 3 is a schematic diagram of a further embodiment depicting a water purifier having a super-chilled zone for a purified water reservoir.

FIG. 4 is a schematic diagram of a further embodiment depicting a water purifier in which purified water is diverted through a water to periodically flush components of the water purifier.

FIG. 5 is a schematic diagram of a further embodiment depicting a water purifier in which heat from warm wastewater is recovered to assist a local heating demand.

FIG. 6 is a schematic diagram of a further embodiment depicting a water purifier in which input water is not pre-cooled by a superheater.

FIG. 7 is a schematic diagram of a further embodiment depicting a water purifier utilizing a direct current (DC) compressor.

### DESCRIPTION OF REFERENCE NUMERALS

1. Water supply
2. Water pre-filter
3. Header tank/superheater
4. Float valve
5. Two position diverter valve
6. LH no return supply valve
7. RH no return supply valve
8. LH or first primary crystallisation chamber
9. RH or second primary crystallisation chamber
10. LH primary air valve
11. RH primary air valve
12. LH secondary crystallisation chamber
13. RH secondary crystallisation chamber
14. LH secondary air valve
15. RH secondary air valve
16. LH pressure control valve
17. RH pressure control valve
18. Lower four way switching valve
19. Refrigerant filter/drier
20. Refrigerant expansion means
21. Upper four way switching valve
22. Sensing bulb (optional)
23. LH wastewater air valve
24. RH wastewater air valve
25. Wastewater reservoir
26. Desuperheater control valve & air inlet
27. Desuperheater
28. Compressor
29. Mechanical pump
30. Purified water no return valve
31. Purified water reservoir
32. Controller
33. Overflow pipe
34. Purified water faucet
35. Overflow drain
36. Wastewater outflow
37. Secondary cooling demand
38. Thermostatic regulation means
39. Heat exchanger for secondary cooling demand
40. Thermally insulated container
41. Super chilled storage zone
42. Purified water return pipe (for cleaning)
43. Two position diverter valve (for cleaning)
44. Thermal store
45. Warm water faucet
46. Warm water outlet pipe
47. DC compressor
48. Solar Panel

### DETAILED DESCRIPTION OF INVENTION

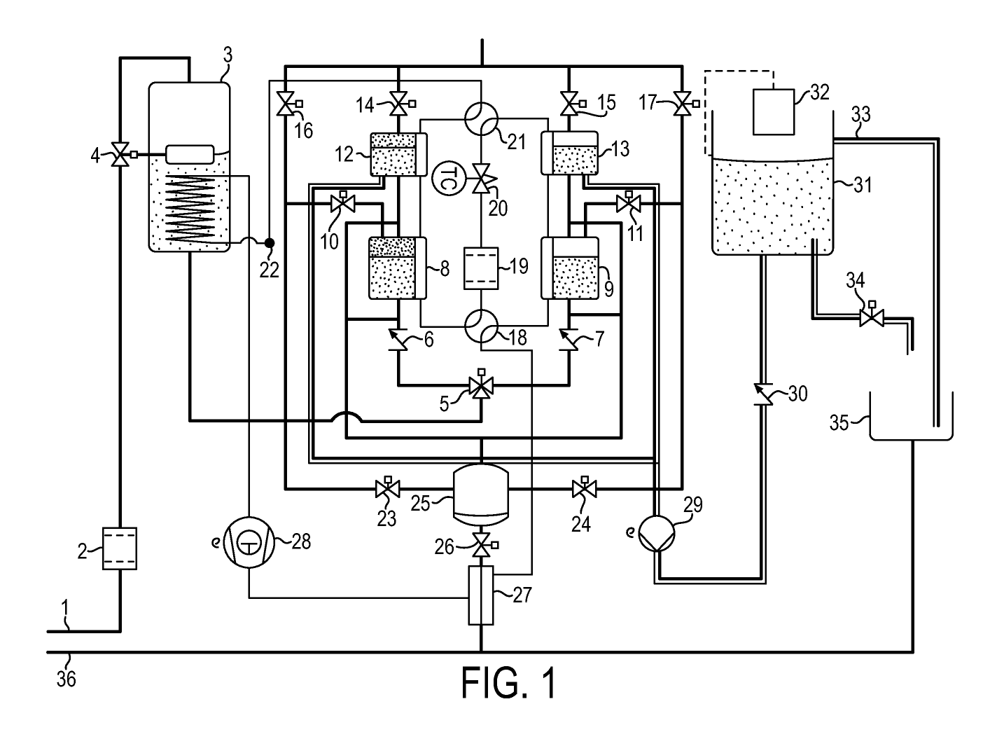

A schematic diagram of an exemplary embodiment is shown in FIG. 1, in which the default status of each valve is closed, and they are opened to perform a specific operation as described in the following text.
a) The input water (1) enters at a mains supply temperature, typically 10-15° C. The water then passes through a pre-filter (2) to remove large suspended particles and is then directed to the header tank/superheater (3), the volume of which is maintained by a float valve (4).
b) At the beginning of the batch crystallization process, water is directed to one of the (at least two) primary crystallization chambers (8 & 9). As seen in FIG. 1, the two primary crystallization chambers include a first or left hand (LH) crystallization chamber 8, and a second or right hand (RH) primary crystallization chamber 9. Flow of supply water is controlled using electronic air release valves (10 & 11) and a two position diverter valve (5). Displaced air remains in the system to create a positive pressure by keeping the pressure control valves (16 & 17) closed. After a prescribed time the active air valve will close, preventing further water from entering the primary crystallization chambers. These chambers work concurrently and out-of-phase of one another; i.e. when one chamber is freezing water (“freezing chamber”—8), the other is thawing ice (“thawing chamber”—9).
c) Secondary crystallization chambers (12 & 13) are preferably positioned alongside the primary crystallization chambers (8 & 9) to receive purified water from the primary chambers and further purify this water with a secondary freeze-thaw sequence. The secondary chambers are connected in parallel to the cold wastewater reservoir (25). The connections between the primary crystallization chambers and the associated air control valves determine the direction of water flow at the appropriate stage in the purification process, as described below.
d) Both crystallization chambers are heat exchangers with thermal contact between the water and refrigerant. The chambers in each series may be connected in series or in parallel in respect to the supply of refrigerant.
e) High pressure liquid refrigerant is expanded through a suitable expansion means (20), preferably a capillary or thermostatic expansion valve (TEV), to a temperature below 0° C. In the case of a TEV, the sensing bulb (22) would be attached to the refrigerant suction line at the entry point to the header tank/superheater. The TEV has the advantage of progressively reducing the evaporating temperature as the thickness of ice increases, whilst maximizing thermodynamic efficiency. The cold refrigerant then enters the primary (8) and secondary (12) crystallization chambers on the left side of the circuit, which causes the water in contact with the heat exchange surfaces to freeze.
f) After a defined time period, sufficient to freeze the desired fraction of water (typically approximately ⅔ is sufficient) in the two freezing chambers ((8 & 12) in this configuration), the excess, non-frozen water is drained from the primary freezing chamber (8) to the wastewater reservoir (25) by opening the left hand (LH) primary (10) and wastewater (23) air valves. The non-frozen water in the secondary freezing chamber (12) is removed by opening the LH secondary (14) and wastewater (23) air valves. Water that has simultaneously thawed in the right hand (RH) primary crystallization chamber (9) flows to the secondary freezing chamber (13) by opening the RH primary (11) and RH secondary (15) air valves, using the positive pressure created in the RH side by the closed the RH pressure control valve (17). During the freezing process, forced convection can be applied by methods such as pumped or gravity flow, electromechanical agitation or mechanical stirring to improve the impurity removal efficacy.
g) The evaporated refrigerant then passes through the upper four way switching valve (21) and is diverted to a heat exchanger (3) which is in thermal contact with the supply water, thus cooling it (superheater). Pre-cooling the supply water reduces the cooling load on the crystallization chambers and consequently the specific refrigerant flow and electrical demand of the compressor.
h) The superheated refrigerant then flows through to a compression means, for example a compressor (28), where the fully-evaporated refrigerant is compressed. The compression means preferably has a variable speed motor and is powered through an inverter from an AC mains electricity supply. The power delivered to the compression means is determined electronically by one or more temperature sensors attached to refrigerant or water pipes.
i) The compressed refrigerant is then de-superheated and partially condensed by passing through desuperheater (27). Chilled wastewater is gravity-drained through the desuperheater (27) from the wastewater reservoir (25) by opening the desuperheater control valve (26) and allowing air to displace the wastewater. The desuperheater (27) directs the wastewater in contraflow with the hot gas exiting the compressor. This heated water is directed to a wastewater outflow (36).
j) The refrigerant is then directed by the lower four-way valve (18) to the heat exchangers in thermal contact with the thawing chambers (9 & 13). The condensing temperature of the refrigerant is sufficient to melt the ice. Once melted, the purified water from the secondary thawing chamber (13) is pumped by the mechanical pump (29) through a no return valve (30) and collected in a reservoir (31) with the RH secondary air valve (15) open. The melt water is diverted from the primary RH crystallization chamber (9) as described in part f). The refrigerant exits the thawing chamber heat exchangers in a fully liquid state, having lost all of its latent heat to the purified water.
k) When sufficient time has passed for the freezing and thawing processes to be completed, the two four-way valves (18 & 21) are switched to alternate the direction of refrigerant flow through the crystallization chambers, so as to reverse the state of all chambers from freezing to thawing or vice versa.
l) Purified water is dispensed under gravity flow from the reservoir (31) via a manually-operated tap (34). An overflow pipe (33) directs excess purified water from the reservoir (31) to the overflow drain (35).

The order of the components as described above is efficient in terms of consumption of energy and supply water; however other embodiments may have these components in a different position. The embodiment of FIG. 1 attempts to minimize the system components such as switching valves and mechanical pumps. It is possible to achieve a comparable outcome (movement of liquid from one stage to another) by a variety of other means such as the addition of further valves, pumps, air valves and air expansion vessels.

As described above, the crystallization chambers may contain multiple compartments to enable the use of sequential freeze-thaw processes to improve the efficacy of impurity removal. In another embodiment of the invention, the user may override this procedure to demand a single freeze-thaw cycle with lower impurity removal but lower energy and water consumption.

In another embodiment of the invention, a supply of the input water is fed to the waste water reservoir, increasing the outgoing water flow rate and thereby reducing the condensing temperature of the refrigerant.

In another embodiment of the invention, a fixed speed compressor is used with a varying duty cycle dependent on the cooling demand and the user-defined volume of purified water.

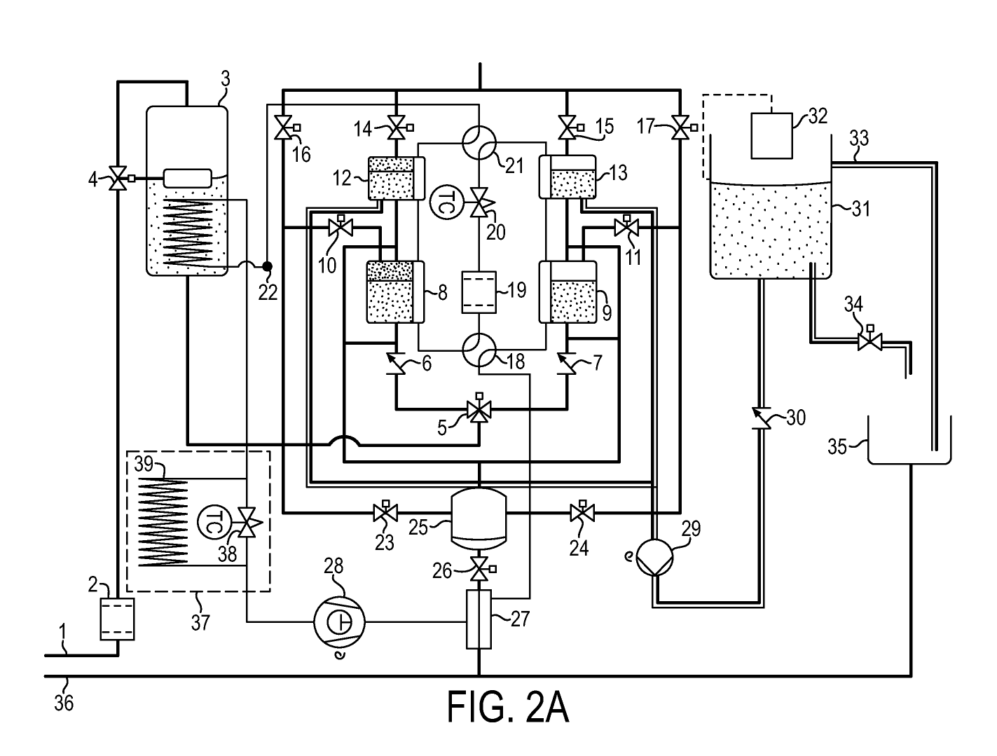

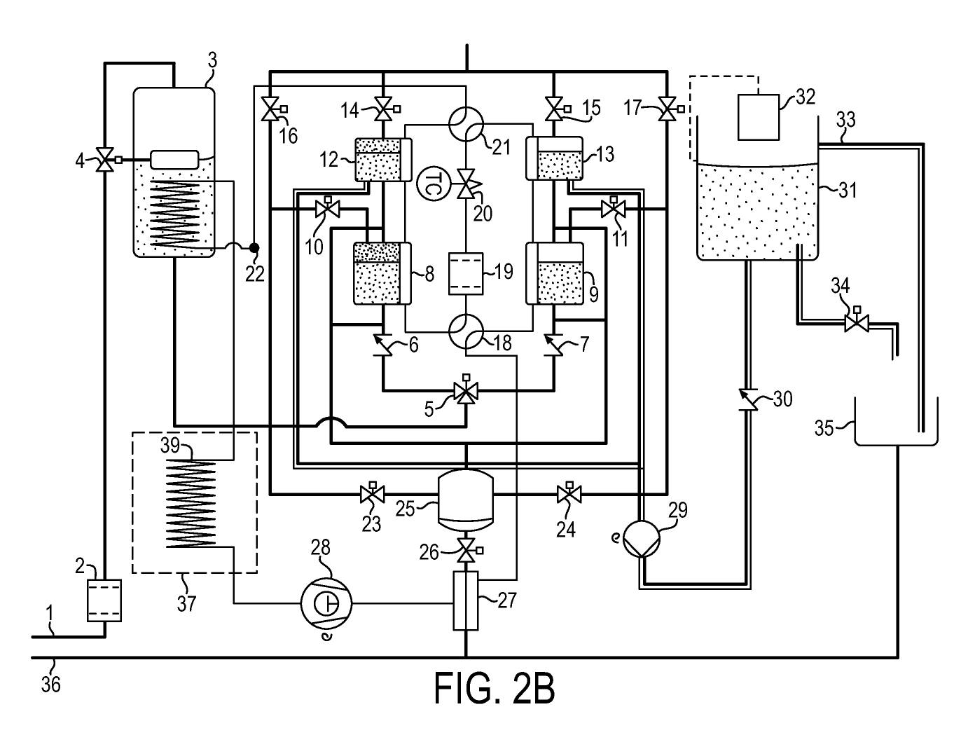

In another embodiment of the invention, shown in FIG. 2a, the heat exchanger (39) serves one or more alternative cooling demands. Examples of possible cooling loads include (but are not limited to): fridge, freezers, air conditioning units, dehumidifiers, photovoltaic panels, microelectronics, electrochemical batteries, fuel cells, food display units, internal combustion engines, compressors, turbochargers, and other motor applications such as pumps. FIG. 2a shows a schematic illustration of this embodiment. In this arrangement the low pressure refrigerant exiting the crystallization chambers is then directed to a further heat exchanger (39) where it gains heat from a heat source (37), thus delivering a secondary cooling function. To regulate this secondary cooling function, a thermostatic regulation means (TRM), also called a thermostatic regulator, (38) is fitted to a bypass pipe in parallel to the heat exchanger (39) and in thermal contact with the heat source. As the temperature of the heat source increases, the TRM acts to increase the cooling available. Similarly as the temperature of the heat source decreases, the TRM acts to reduce the amount of cooling available. This arrangement passively regulates the temperature of the heat source with minimal impact on the water purification performance. Examples of possible thermostatic regulators include (but are not limited to): regulating valves, bypass lines, fans, intermediate heat transfer circuit, and other comparable devices as are known in the art.

FIG. 2b shows a modification of the embodiment of FIG. 2a where no mechanism for independently controlling the temperature of the secondary cooling demand is used; i.e. the refrigerant flows directly through heat exchanger (39) without using thermostatic regulator in a bypass arrangement.

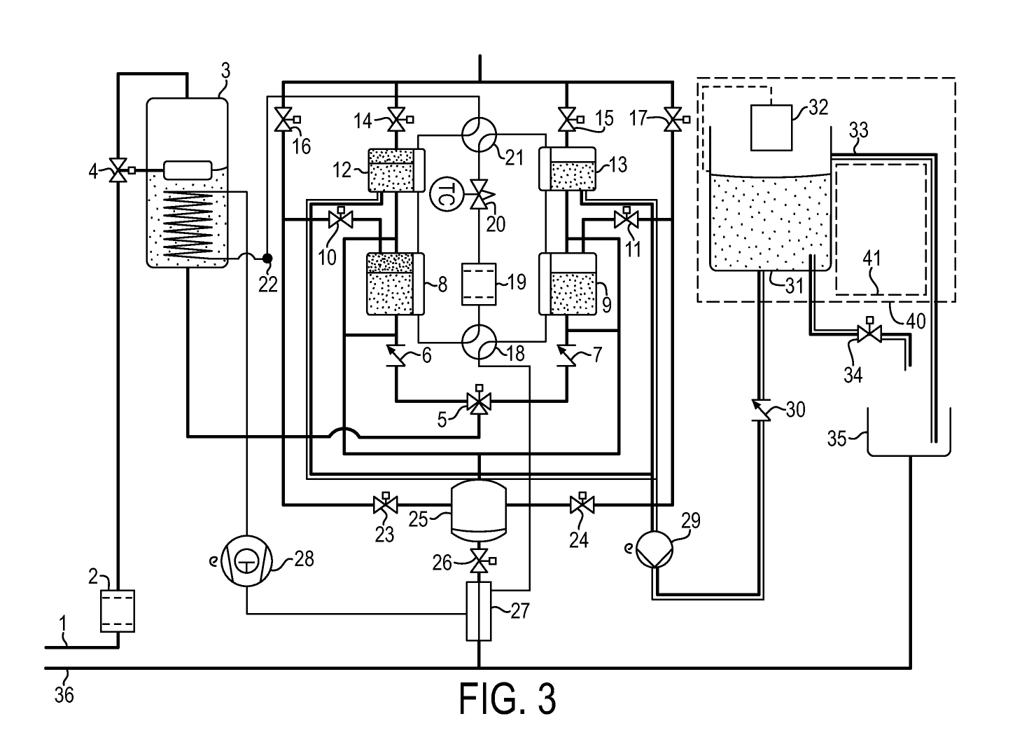

In a further embodiment, shown in FIG. 3, another cooling demand is met directly by the chilled purified water. A thermally insulated container (40) surrounds the purified water reservoir and creates a ‘super-chilled zone’ (41) suitable for lower temperature applications such as drinks storage.

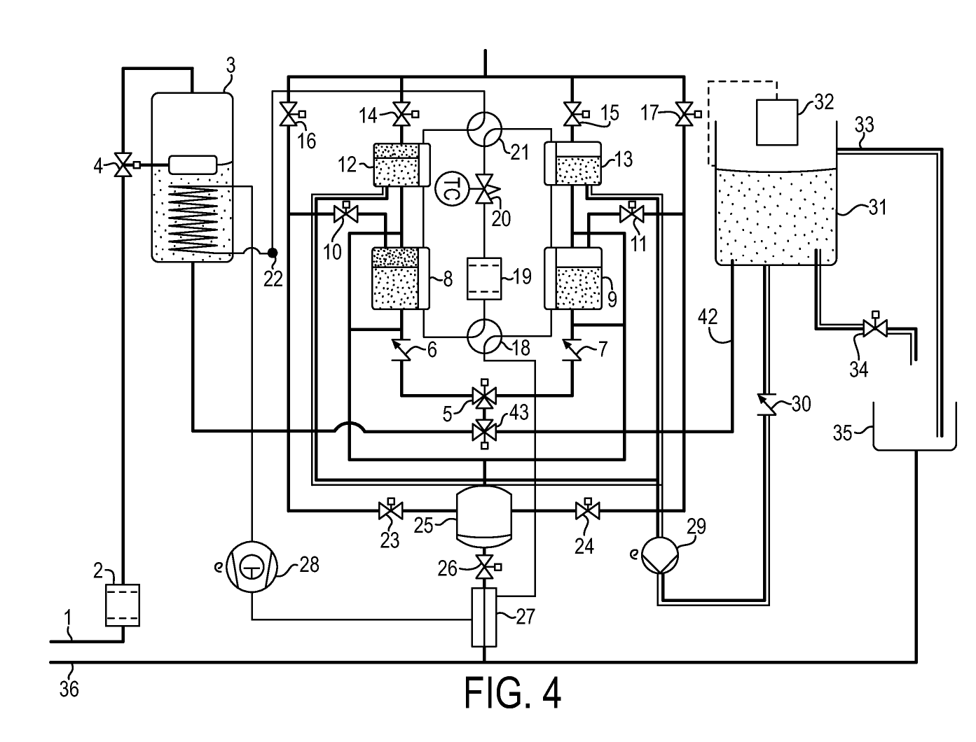

In another embodiment of the invention, shown in FIG. 4, the flow of purified water is diverted so that it flows through the water circuit. This can be used to periodically flush the crystallization chambers and purified water pipes with clean water and also to drain purified water if it has been stagnant for an excessive period of time.

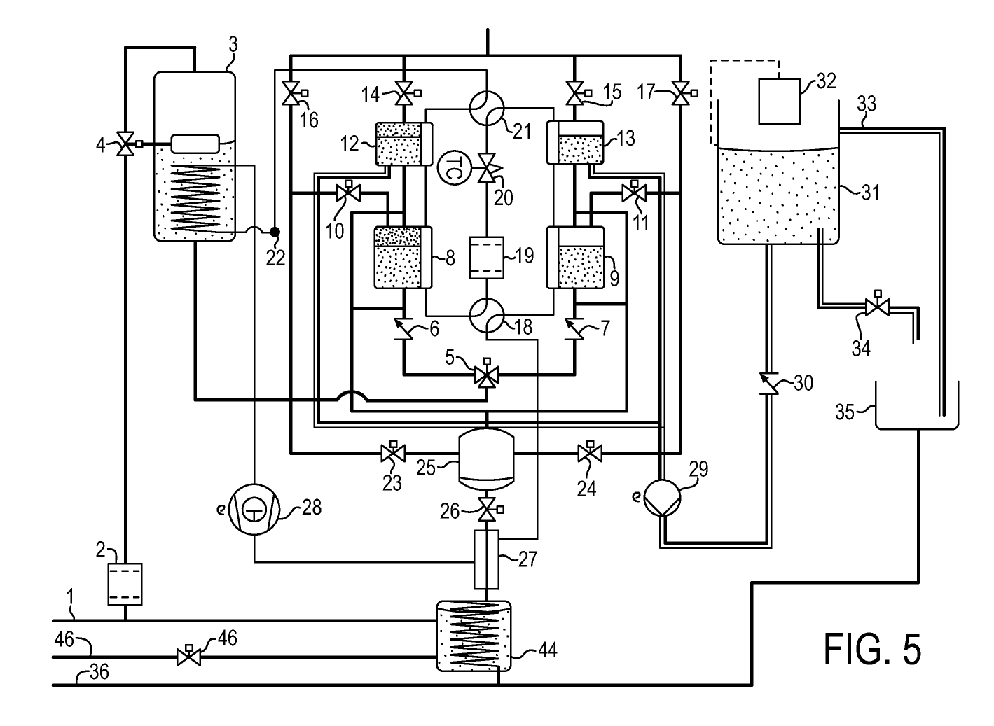

In another embodiment of the invention, shown in FIG. 5, heat from the warm wastewater is recovered to assist a local heating demand. This is achieved by placing a heat exchanger (as part of a thermal store (44)) on the wastewater outflow pipe (46). Flow through the thermal store is controlled by the warm water faucet (45).

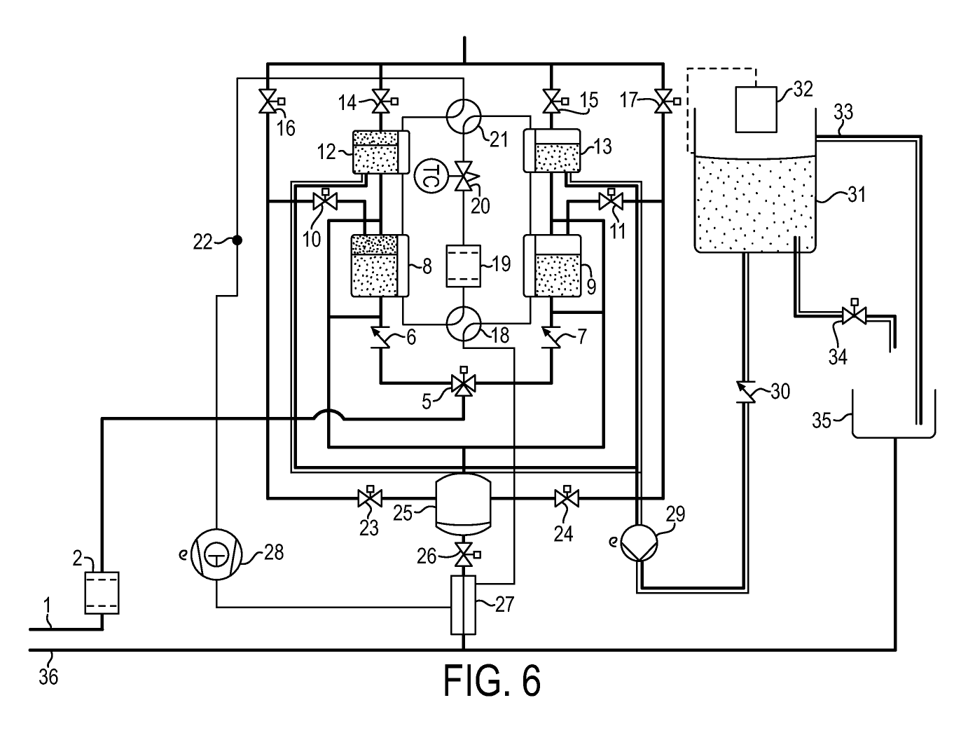

In another embodiment of the invention, shown in FIG. 6, the pump does not divert the input water through the superheater to pre-cool the water prior to entering the batch crystallization chambers. This configuration may be used in cooler countries or areas where the supply temperature is more controlled due to being ground cooled.

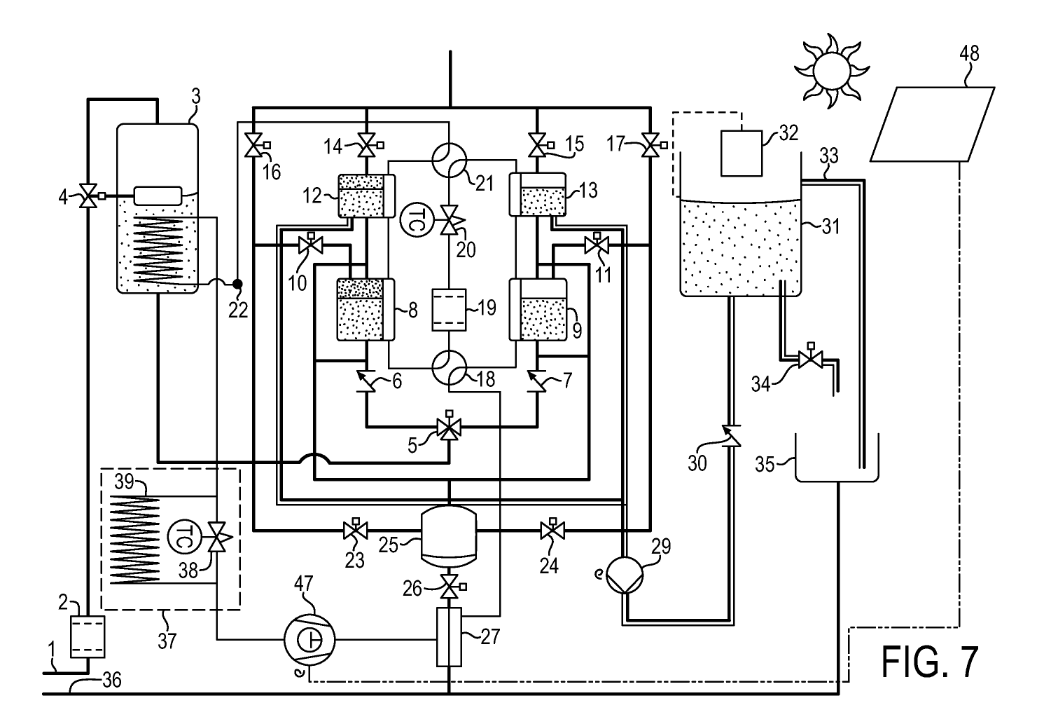

In another embodiment of the invention, shown in FIG. 7, a direct current (DC) compressor (47) is used to enable the device to operate directly from a battery or DC generator, such as one or more solar photovoltaic modules (48) for use in off-grid applications such as field hospitals where the device may be combined with a vaccine refrigerator or an air conditioner, as shown in FIG. 7.

In accordance with the above description, an aspect of the invention is a water purifier. In exemplary embodiments, the water purifier includes a first crystallization chamber and a second crystallization chamber that each receives a supply of input water; wherein each of the first and second crystallization chambers is a freeze/thaw chamber in which water is alternately frozen and thawed, and a refrigerant circuit that alternately supplies cold refrigerant to freeze the input water in one of the crystallization chambers, and supplies heated refrigerant to the other of the crystallization chambers to thaw the input water. The first and second crystallization chambers operate concurrently and out-of-phase whereby heat recovered from freezing in one of the crystallization chambers is transferred by the refrigerant circuit for use in thawing in the other of the crystallization chambers. The refrigerant circuit includes a desuperheater that sensibly cools and at least partially condenses heated refrigerant such that the waste heat of compression is rejected into wastewater via contraflow heat exchange with the heated refrigerant.

In an exemplary embodiment of the water purifier, the refrigerant circuit includes at least two valves that are switched to alternate the direction of refrigerant flow through the first and second crystallization chambers to alternate states of the crystallization chambers between freezing and thawing while maintaining unidirectional refrigerant flow through the desuperheater.

In an exemplary embodiment of the water purifier, the valves are electromechanical four-way valves.

In an exemplary embodiment of the water purifier, the refrigerant circuit further includes a heat exchanger in thermal contact with a water supply that provides the input water, wherein the heat exchanger receives heated refrigerant after freezing input water in one of the crystallization chambers, and acts as a superheater whereby the refrigerant removes heat from the water supply to pre-cool the input water.

In an exemplary embodiment of the water purifier, the refrigerant circuit further includes a compression means that receives and compresses the superheated refrigerant from the heat exchanger.

In an exemplary embodiment of the water purifier, the desuperheater receives the compressed refrigerant from the compression means and at least partially condenses the refrigerant.

In an exemplary embodiment of the water purifier, the refrigerant circuit further includes a wastewater reservoir that supplies chilled wastewater to the desuperheater to at least partially condense the refrigerant.

In an exemplary embodiment of the water purifier, excess supply water drains from at least one of the crystallization chambers into the wastewater reservoir to provide the wastewater.

In an exemplary embodiment of the water purifier, a portion of water from the input water supply is part of the wastewater received by the wastewater reservoir.

In an exemplary embodiment of the water purifier, the water purifier further includes a second heat exchanger in series with the compressor, wherein the second heat exchanger performs an auxiliary cooling function.

In an exemplary embodiment of the water purifier, the first and second crystallization chambers each comprises a primary crystallization chamber and a secondary crystallization chamber.

In an exemplary embodiment of the water purifier, the water purifier further includes a pure water reservoir for collecting thawed water from the crystallization chambers.

In an exemplary embodiment of the water purifier, the water purifier further includes a float valve for isolating the supply of input water from a mains water supply, thereby cutting off the input water supply to the first and second crystallization chambers.

In an exemplary embodiment of the water purifier, the refrigerant is one of a pure refrigerant, an azeotropic refrigerant, or a zeotropic blend of refrigerants.

In an exemplary embodiment of the water purifier, the refrigerant circuit includes a vapor compression circuit with a compression means and a mechanical expansion structure.

Another aspect of the invention is a method of purifying water. In exemplary embodiments, the method of purifying water includes the steps of supplying input water to each of a first crystallization chamber and a second crystallization chamber; wherein each of the first and second crystallization chambers is a freeze/thaw chamber in which water is alternately frozen and thawed, and circulating a refrigerant through a refrigerant circuit to alternately supply cold refrigerant to freeze the input water in one of the crystallization chambers, and supply heated refrigerant to the other of the crystallization chambers to thaw the input water. The first and second crystallization chambers are operated concurrently and out-of-phase whereby heat recovered from freezing in one of the crystallization chambers is transferred by the refrigerant circuit for use in thawing in the other of the crystallization chambers. The refrigerant circuit comprises a desuperheater that sensibly cools and at least partially condenses heated refrigerant such that the waste heat of compression is rejected into wastewater via contraflow heat exchange with the heated refrigerant.

In an exemplary embodiment of the method of water purifier, the method further includes providing a heat exchanger in thermal contact with a water supply that provides the input water, wherein the heat exchanger receives heated refrigerant after freezing input water in one of the crystallization chambers, and acts as a superheater whereby the refrigerant removes heat from the water supply to pre-cool the input water.

In an exemplary embodiment of the method of water purifier, the method further includes compressing the superheated refrigerant from the heat exchanger.

In an exemplary embodiment of the method of water purifier, the desuperheater receives the compressed refrigerant to at least partially condense the refrigerant.

In an exemplary embodiment of the method of water purifier, the method further includes collecting the thawed water from the crystallization chambers into a pure water reservoir.

Although the invention has been shown and described with respect to a certain embodiment or embodiments, equivalent alterations and modifications may occur to others skilled in the art upon the reading and understanding of this specification and the annexed drawings. In addition, while a particular feature of the invention may have been described above with respect to only one or more of several embodiments, such feature may be combined with one or more other features of the other embodiments, as may be desired and advantageous for any given or particular application.

### INDUSTRIAL APPLICABILITY

The invention may be utilized in the manufacture of energy efficient domestic water purifying units based on a batch crystallization purification process. Such units would provide water purification and possibly additional cooling demand applications such as a refrigerator or air conditioning unit.

1. A water purifier comprising:
a first crystallization chamber and a second crystallization chamber that each receives a supply of input water; wherein each of the first and second crystallization chambers is a freeze/thaw chamber in which water is alternately frozen and thawed; and
a refrigerant circuit that alternately supplies cold refrigerant to freeze the input water in one of the crystallization chambers, and supplies heated refrigerant to the other of the crystallization chambers to thaw the input water;
wherein the first and second crystallization chambers operate concurrently and out-of-phase whereby heat recovered from freezing in one of the crystallization chambers is transferred by the refrigerant circuit for use in thawing in the other of the crystallization chambers; and
wherein the refrigerant circuit comprises a desuperheater that sensibly cools and at least partially condenses heated refrigerant such that the waste heat of compression is rejected into wastewater via contraflow heat exchange with the heated refrigerant.

2. The water purifier of claim 1, wherein the refrigerant circuit comprises at least two valves that are switched to alternate the direction of refrigerant flow through the first and second crystallization chambers to alternate states of the crystallization chambers between freezing and thawing while maintaining unidirectional refrigerant flow through the desuperheater.

3. The water purifier of claim 2, wherein the valves are electromechanical four-way valves.

4. The water purifier of claim 1, wherein the refrigerant circuit further comprises a heat exchanger in thermal contact with a water supply that provides the input water,
wherein the heat exchanger receives heated refrigerant after freezing input water in one of the crystallization chambers, and acts as a superheater whereby the refrigerant removes heat from the water supply to pre-cool the input water.

5. The water purifier of claim 4, wherein the refrigerant circuit further comprises a compression means that receives and compresses the superheated refrigerant from the heat exchanger.

6. The water purifier of claim 5, wherein the desuperheater receives the compressed refrigerant from the compression means and at least partially condenses the refrigerant.

7. The water purifier of claim 6, wherein the refrigerant circuit further comprises a wastewater reservoir that supplies chilled wastewater to the desuperheater to at least partially condense the refrigerant.

8. The water purifier of claim 7, wherein excess supply water drains from at least one of the crystallization chambers into the wastewater reservoir to provide the wastewater.

9. The water purifier of claim 8, wherein a portion of water from the input water supply is part of the wastewater received by the wastewater reservoir.

10. The water purifier of claim 2, further comprising a second heat exchanger in series with the compressor, wherein the second heat exchanger performs an auxiliary cooling function.

11. The water purifier of claim 1, wherein the first and second crystallization chambers each comprises a primary crystallization chamber and a secondary crystallization chamber.

12-14. (canceled)

15. The water purifier of claim 1, wherein the refrigerant circuit comprises a vapor compression circuit with a compression means and a mechanical expansion structure.

16. A method of purifying water comprising the steps of:
supplying input water to each of a first crystallization chamber and a second crystallization chamber; wherein each of the first and second crystallization chambers is a freeze/thaw chamber in which water is alternately frozen and thawed; and
circulating a refrigerant through a refrigerant circuit to alternately supply cold refrigerant to freeze the input water in one of the crystallization chambers, and supply heated refrigerant to the other of the crystallization chambers to thaw the input water;
wherein the first and second crystallization chambers are operated concurrently and out-of-phase whereby heat recovered from freezing in one of the crystallization chambers is transferred by the refrigerant circuit for use in thawing in the other of the crystallization chambers, and
wherein the refrigerant circuit comprises a desuperheater that sensibly cools and at least partially condenses heated refrigerant such that the waste heat of compression is rejected into wastewater via contraflow heat exchange with the heated refrigerant.

17. The method of purifying water of claim 16, further comprising providing a heat exchanger in thermal contact with a water supply that provides the input water,
wherein the heat exchanger receives heated refrigerant after freezing input water in one of the crystallization chambers, and acts as a superheater whereby the refrigerant removes heat from the water supply to pre-cool the input water.

18. The method of purifying water of claim 17, further comprising compressing the superheated refrigerant from the heat exchanger.

19. The method of purifying water of claim 18, wherein the desuperheater receives the compressed refrigerant to at least partially condense the refrigerant.

20. (canceled)

21. A fluid purifier comprising:
a first crystallization chamber and a second crystallization chamber that each receives a supply of input fluid; wherein each of the first and second crystallization chambers is a freeze/thaw chamber in which fluid is alternately frozen and thawed; and
a refrigerant circuit that alternately supplies cold refrigerant to freeze the input fluid in one of the crystallization chambers, and supplies heated refrigerant to the other of the crystallization chambers to thaw the input fluid;
wherein the first and second crystallization chambers operate concurrently and out-of-phase whereby heat recovered from freezing in one of the crystallization chambers is transferred by the refrigerant circuit for use in thawing in the other of the crystallization chambers; and
wherein the refrigerant circuit comprises a desuperheater that sensibly cools and at least partially condenses heated refrigerant such that the waste heat of compression is rejected into waste fluid via contraflow heat exchange with the heated refrigerant.

22. The fluid purifier of claim 21, wherein the fluid is a fluid mixture in which water is a primary component.

23. A method of purifying a fluid comprising the steps of:
supplying input fluid to each of a first crystallization chamber and a second crystallization chamber; wherein each of the first and second crystallization chambers is a freeze/thaw chamber in which fluid is alternately frozen and thawed; and
circulating a refrigerant through a refrigerant circuit to alternately supply cold refrigerant to freeze the input fluid in one of the crystallization chambers, and supply heated refrigerant to the other of the crystallization chambers to thaw the input fluid;
wherein the first and second crystallization chambers are operated concurrently and out-of-phase whereby heat recovered from freezing in one of the crystallization chambers is transferred by the refrigerant circuit for use in thawing in the other of the crystallization chambers, and
wherein the refrigerant circuit comprises a desuperheater that sensibly cools and at least partially condenses heated refrigerant such that the waste heat of compression is rejected into waste fluid via contraflow heat exchange with the heated refrigerant.

24. The method of purifying a fluid of claim 23, wherein the fluid is a fluid mixture in which water is a primary component.
